(19) United States
(12) Patent Application Publication
(10) Pub. No.: US 2005/0228712 A1
(43) Pub. Date: Oct. 13, 2005

(54) Systems and methods for improving audits

(75) Inventors: William Bornstein, Stormville, NY (US); Anthony Cappa Spielberg, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/821,051

(22) Filed: Apr. 8, 2004

(51) Int. Cl. G06F 17/60

(52) U.S. Cl. 705/10

(57) ABSTRACT

Systems and arrangements for improving audits such as technical audits in semiconductor fabrication facilities and especially controlled environments are contemplated. Embodiments include a processing device with an interactive interface designed to request information about one or more quality issues. Further embodiments focus requests to questions that are relevant to the particular piece of equipment, process, maintenance procedure, etc. . . . , in light of answers received from the auditor for prior questions. Still further embodiments provide some or all of the potential answers to the questions so an auditor may simply select the correct answer based upon observations and/or interaction with the staff at the fabrication facility. Several embodiments are adapted to operate on small computers such as Personal Digital Assistants (PDAs) that are allowed entry into many or all controlled environments such as clean rooms.

### FIELD OF INVENTION

The present invention is in the field of data processing systems and, in particular, a data processing system and method for improving audits such as technical audits within controlled environments.

### BACKGROUND

Companies such as International Business Machines Corporation (IBM) purchase large quantities of supplies from various fabricators. When the quality, quantity, and reliability of the product(s) can have a significant impact on the quality, quantity, and reliability of the corresponding end-product, companies send auditors out to potential fabricators to review and evaluate quality issues associated with supplying the product(s). In particular, companies may want to review the quality of, e.g., the manufacturing process and equipment, and the quality and frequency of maintenance procedures, quality assurance procedures, and the like, to make an independent assessment (independent of the fabricator's assessment and assurances) of the ability of the fabricator to supply the quantity and quality of reliable product(s). For example, IBM may perform market analyses to determine that a certain number of IBM eServers™ will be sold by the third quarter. The number of IBM eServersT may require IBM to purchase 100,000 dynamic random access memory (DRAM) chips. IBM wants to make sure that it can supply the reliable, quality computers on time so that it doesn't lose out on potential sales and, at the same time, cannot feasibly purchase too many of the chips and make a profit. Nor can IBM feasibly receive too many faulty chips and still meet the production requirements for the IBM eServer™. Thus, IBM has a significant interest in verifying the fabricator's assurances that the fabricator can supply the quantity and quality of reliable chips for which IBM intends to contract.

Depending upon the complexity of the product and the experience the company has had with the particular fabricator, audits of the fabricator may be fairly cursory. On the other hand, if the fabricator is new or has not supplied the product to the company before, and the process for creating the product is fairly complex, a very intensive audit of the fabricator and the fabricator's facility may be desirable.

More intensive audits of, e.g., semiconductor fabricators, requires the auditor to request very detailed information from the fabricator and to tailor the questions dynamically based upon information that the auditor receives from the fabricator. The scope and content of such questions typically require auditors to have a broad and deep understanding of the subject matter, which is acquired through many years of experience. As a result, in many organizations, only a few of the most senior staff members have the expertise necessary to audit and critique new fabricators.

Checklists are often created and updated by the more senior staff members to enable less-experienced staff members to conduct audits effectively. Such checklists are intended to provide the less-experienced staff members with the ability to conduct an audit with a higher level of accuracy and completeness. The checklists also represent a substantial amount of work, which is held in confidence by the company that created the work. For instance, if a checklist were to fall into the hands of a competitor with a less experienced auditing staff, that competitor would have the advantage of the experience detailed in the checklist without spending the time and money to hire someone to prepare such a checklist.

Paper-based checklists are often used in real-life auditing situations, but often with significant difficulty. If the subject matter is complex, the sheer size of the checklist makes it difficult for an auditor to navigate and use the checklist quickly. Moreover, semiconductor fabricators typically have hundreds or even thousands of employees and hundreds of pieces of equipment performing tens of thousands of operations in a controlled environment and, in some environments, paper is forbidden. Controlled environments such as clean rooms are environments in which the fabricator implements restrictions on the anything from paper to machines to chemicals that may enter. These restrictions are designed to attenuate the introduction of certain elements into the environment that could adversely affect the ability to produce a product.

In other environments, the use of paper from outside the fabricator's facility is forbidden so an auditor interested in bringing a checklist into, e.g., a clean room must surrender the checklist to the fabricator for copying onto paper approved for entry into the clean room. The original checklist then remains outside the clean room and additional delays are encountered when, for some reason, one or more pages of the checklist are either missing or out of order.

Computer-based checklists are an improvement over paper-based checklists, allowing easier management of large and complex documents. However, common applications like a word-processing document or a spreadsheet often prove unwieldy for auditing applications. Moreover, auditing often requires the capture of information while walking around a facility, which makes the use of a notebook computer impractical.

There is therefore a need, which has existed for a long time without a satisfactory solution, for methods, systems, and media for managing an audit checklist in a manner suited for auditing a controlled environment such as a clean room.

### SUMMARY OF THE INVENTION

The problems identified above are in large part addressed by systems and arrangements for improving audits such as technical audits within controlled environments. The method generally includes determining a quality issue to address, the quality issue being associated with a product, wherein the product is the subject of the audit; selecting a group of questions associated with the quality issue; posing a question of the group of questions to gather information related to evaluation of the quality issue via an interactive interface adapted for operation within the controlled environment; determining a sub-group of the group of questions, the sub-group being selected based upon an association with the information received in response to the question; and storing the information.

Another embodiment provides a method for performing an audit. The method may include interacting via an interactive interface to invoke a response to a question from a group of questions associated with the audit; narrowing the group of questions to a sub-group of the group based upon the response to the question, wherein the sub-group of questions are relevant to a quality issue in light of the response; and storing the response for analysis.

A further embodiment provides an apparatus for use within a controlled environment to improve an audit. The apparatus may include an interactive interface to invoke a response to a question from a group of questions associated with the audit and to narrow the group to a sub-group based upon the response to the question, wherein the sub-group is relevant to a quality issue in light of the response; a question database coupled with the interactive interface, the question database having the group of questions, wherein the group of questions are invoked in an order based upon the response; and an audit database coupled with the interactive interface, to store data, wherein the data represents the response and responses to other questions from the group.

One embodiment provides a machine-accessible medium containing instructions, which when executed by a machine, cause said machine to perform operations. The operations generally include determining a quality issue to address, the quality issue being associated with a product, wherein the product is the subject of the audit; selecting a group of questions associated with the quality issue; posing a question of the group of questions to gather information related to evaluation of the quality issue via an interactive interface adapted for operation within the controlled environment; determining a sub-group of the group of questions, the sub-group being selected based upon an association with the information received in response to the question; and storing the information.

Another embodiment provides machine-accessible medium containing instructions, which when executed by a machine, cause said machine to perform operations. The operations generally involve interacting via an interactive interface to invoke a response to a question from a group of questions associated with the audit; narrowing the group of questions to a sub-group of the group based upon the response to the question, wherein the sub-group of questions are relevant to a quality issue in light of the response; and storing the response for analysis.

### BRIEF DESCRIPTION OF THE DRAWINGS

Other purposes and advantages of the invention will become apparent upon reading the following detailed description and upon reference to the accompanying drawings in which like references may indicate similar elements:

FIG. 1 depicts a system including a processing device with an interactive interface for auditing a controlled environment;

FIG. 2 depicts an alternative processing device having an audit analyzer for auditing fabrication facilities including controlled environments;

FIGS. 3A-B depict a personal digital assistant (PDA) such as the processing device of FIG. 1 in two different states to illustrate a progression from state to state of the interactive interface;

FIG. 4A-B depict embodiments of a state diagram for a database in general and more specific modes for improving performance and increasing efficiency of audits of a fabrication facility; and

FIG. 5 depicts a flowchart of embodiments for improving performance and increasing efficiency of audits of a fabrication facility.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems and arrangements for improving audits such as technical audits in semiconductor fabrication facilities and especially controlled environments are disclosed. Embodiments include a processing device with an interactive interface designed to request information about one or more quality issues. When auditing a piece of equipment, for instance, the interactive interface of many embodiments focus requests for information on one or more quality issues related to that piece of equipment. Further embodiments focus requests to questions that are relevant to the particular piece of equipment, process, maintenance procedure, etc. . . . , in light of answers received from the auditor for prior questions. Still further embodiments provide some or all of the potential answers to the questions so an auditor may simply select the correct answer based upon observations and/or interaction with the staff at the fabrication facility. Several embodiments are adapted to operate on small computers such as Personal Digital Assistants (PDAs) that are allowed entry into many or all controlled environments such as clean rooms.

Advantageously, an auditor can audit a clean room, for instance, in potentially half the time previously achievable. Further, embodiments can improve the quality of audits performed by less experienced auditors by building the interactive interface with questions and answers prepared by an experienced auditor so the less experienced auditors can be guided through the auditing process. Some embodiments may also be implemented as training devices for auditors. Further, the standardized format of audits of different facilities, inherent to many embodiments, facilitates comparison between different fabricators, advantageously highlighting strengths and weaknesses of various fabricators.

While specific embodiments will be described below with reference to semiconductor fabrication facilities and controlled environments such as clean rooms, those of skill in the art will realize that embodiments of the present invention may advantageously be implemented in other, similar facilities whether or not the facilities include controlled environments like clean rooms.

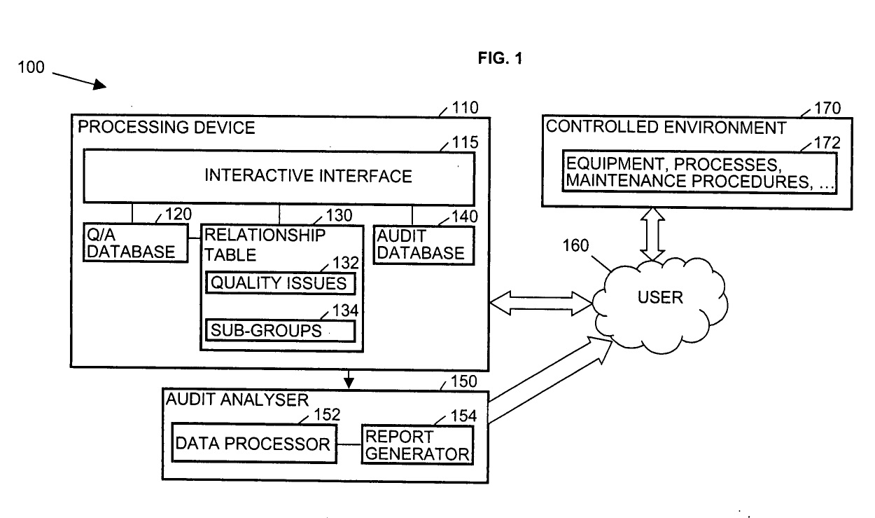

Turning now to the drawings, FIG. 1 depicts an embodiment of a system 100 for improving technical audits such as technical audits in controlled environments. System 100 includes a processing device 110 coupled with a user 160 and a controlled environment 170 via user 160 to perform a technical audit in the controlled environment. In particular, processing device 110 may include a Personal Digital Assistant (PDA) that the user 160, an auditor for controlled environment 170, can bring into the controlled environment 170 to perform a technical audit. System 100 also includes an audit analyzer 150 to analyze data from the audit after completion of the audit, to evaluate the performance of the controlled environment according to the audit. Advantageously, the audit analyzer 150 may remain outside the controlled environment 170 during the information-gathering portion of the audit and the processing device 110 may be adapted for entry into the controlled environment 170. Alternative embodiments may be adapted to allow the processing device 110 to remain outside the controlled environment 170 while the user enters the controlled environment 170 and communicates with the processing device wirelessly, such as through infrared or other radiation links, or in other manners.

Processing device 110 may include a mobile computer such as a PDA, laptop, a cellular phone, or similarly small processing device. Processing device 110 includes input and output (I/O) devices such as a touch screen, buttons, a keyboard, a display, or the like to facilitate interaction between user 160 and hardware and/or software implemented functionality of processing device 110. More specifically, processing device may include hardware, software, firmware, or the like to help user 160 gather data related to one or more quality issues associated with controlled environment 170 and the I/O devices offer one or more methods of communication for user interaction.

Processing device 110 includes interactive interface 115, question/answer (Q/A) database 120, relationship table 130, and audit database 140. Interactive interface 115 may be a user interface designed to select questions from Q/A database 120 based upon default questions, general questions, and/or relationships between sets of questions and answers from user 160 to questions asked about the controlled environment 170. For example, interactive interface 115 may request general information about a piece of equipment or process to select the quality issue(s) to address based upon associations between the quality issue(s), groups of questions in Q/A database 120, and the information received from user 160 in response to the requests. Answers to questions asked from the remaining groups of questions may then narrow the number of remaining questions for the quality issue(s).

In several embodiments, an experienced auditor may incorporate knowledge and experience related to audits into interactive interface 115, Q/A database 120, and relationship table 130 via software packages designed to create checklists. For example, an auditor may use a program such as Pocket PC Creations™ to create such an auditing tool for a PDA.

Q/A database 120 may include a table having questions associated with or grouped by quality issues. Quality issues may focus on a quality and/or reliability associated with a piece of equipment, fabrication process, maintenance procedure, quality control procedure, and/or the like. The scope of the questions, however, is typically broad enough to cover more than one specific fabrication facility so only a sub-set of the questions for the quality issue may be relevant or applicable to the controlled environment 170. Each question of Q/A database 120 may also be associated with one or more answers and, in several embodiments, the answers may include one or more ranges of potential values or alternatives.

An experienced auditor may develop the questions, associate the questions with answers, and store the questions with the answers in Q/A database 120, advantageously allowing other auditors to benefit from the experience during audits. In other embodiments, Q/A database 120 may include a list of questions associated with answers for some of the questions, and relationship table 130 or interactive interface 115 may provide associations between the questions, answers and quality issues.

In some embodiments, different auditors may provide the questions and answers and establish relationships between answers and further questions of a sub-group of questions related to a quality issue. In particular, each such auditor may provide information for the processes and/or equipment for which they have specialized training.

Relationship table 130 may include, e.g., a structured list of associations describing relationships between questions, answers, and quality issues. For example, relationship table 130 includes quality issues 132 and sub-groups 134 to distinguish sub-goups of questions in Q/A database 120 related to a quality issue. More specifically, quality issues 132 can provide a list of quality issues that may be addressed for controlled environment 170. The quality issues 132 may each be associated with sub-groups 134 of the questions in Q/A database 120. Thus, once a particular quality issue is identified as a subject of the audit of the controlled environment 170, interactive interface 115 accesses relationship table 130 to determine a sub-group of questions from Q/A database 120 that are related the quality issue. Then interactive interface 115 may ask only questions that are applicable to the quality issue for the controlled environment 170. For instance, upon arriving at a set of equipment designed to etch a circuit pattern into a silicon wafer, user 160 may select the process of etching a circuit pattern. Interactive interface 115, in response, searches quality issues 132 to identify one or more groups of questions related to the process of etching a silicon wafer. Relationship table 130 may then return more than one quality issue, each being associated with a different portion of the process or a different piece of equipment associated with the process.

Upon determining the quality issue(s) related to etching a silicon wafer, interactive interface 115 may begin questioning user 160 about the process. For example, interactive interface 115 may ask questions associated with the quality issue(s) in the order provided in Q/A database 120 or in an order provided by relationship table 130. The first question, for instance, may request the manufacturer of the laser. Upon responding with the laser's manufacturer, interactive interface 115 may reduce the set of questions and/or answers related to potential model numbers for the laser based upon the laser's actual manufacturer.

Audit database 140 stores the answers selected or entered by user 160 at least until the answers may be transmitted to audit analyzer 150. Audit database 140 may provide a list of answers along with data relating the answer to a question of Q/A database 120. For example, a question related to the maintenance schedule for a mirror assembly may be designated as question 3B in Q/A database 120 so the answer for that question, when stored in audit database 140, may be associated with the designation 3B. In many embodiments, the data of audit database 140 is compressed to save on storage space.

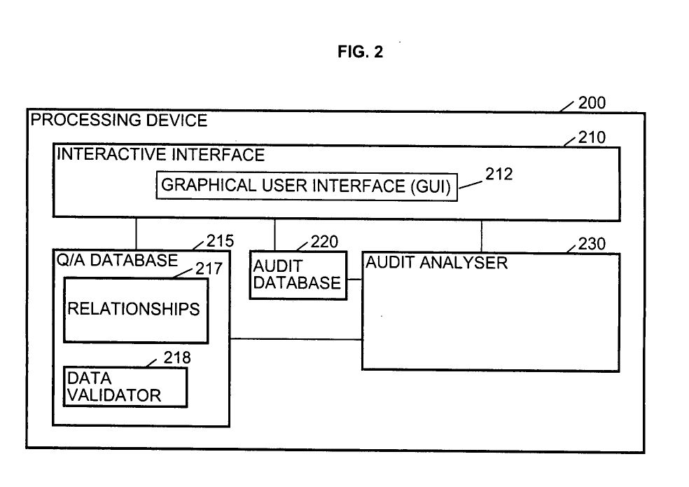

Audit database 140 may include volatile memory such as dynamic random access memory (DRAM) and/or non-volatile memory such as flash memory. In some embodiments, for instance, the memory may be removable, such as Memory Sticks™ or CompactFlash™ cards, allowing audit database 140 to be removed from processing device 110 upon completion or possibly during the audit process. Another flash memory device may be inserted into processing device 110 to capture data for the remainder of the audit while the removed flash memory device can be coupled with audit analyzer 150 to begin or begin preparations for analyses of the audit data. Transferring the audit database 140 to a separate audit analyzer 150, whether by physically removing a memory device or via a communications port, advantageously allows processing device 110 to remain small and easy to use while traveling around the clean room during an audit. In other embodiments, audit analyzer 150 may be incorporated into a processing device such as processing device 200 in FIG. 2.

Audit analyzer 150 may include a device having a processor or state machine to analyze data captured by processing device 110 about the controlled environment 170. More specifically, audit analyzer 150 includes a data processor 152 and a report generator 154. Data processor 150 processes answers to questions asked with regard to one or more quality issues, and, in particular, processes the answers to find problems with the a process, procedure, or equipment associated with the controlled environment 170. Advantageously, the processes for analyzing the answers may be provided by one or more experienced auditors so less experienced auditors such as user 160, may provide just as high of quality analyses for the controlled environment 170 as would the experienced auditor(s). For instance, audit analyzer 150 may compare quality issues associated with different pieces of equipment and determine that a maintenance schedule for a particular piece of equipment is of the highest degree of concern for user 160.

In many embodiments, audit analyzer 150 may provide a rating for the, e.g., maintenance procedure also. For instance, although the maintenance schedule is of the highest concern for user 160, the concern rating may only be a five out of ten and, depending upon the preferences of the company that the user 160 represents, a rating of five for a maintenance procedure may be acceptable. Thus, while user 160 may suggest that increasing the frequency of the maintenance or modifying the procedure for the maintenance will improve reliability and/or quality of the resulting products, user 160 and the company that user 160 represents may not require any change to the maintenance procedure be implemented to approve the fabricator as a supplier of that product.

In other embodiments, audit analyzer 150 may also generate reports to compare results from more than fabricators' facilities. In particular, audit analyzer 150 may include data from prior audits by the same or other auditors and, by using the same logic or software as processing device 110, the audit databases from each prior audit may be structured the same as or substantially similar to audit database 140. In further embodiments, audit analyzer 150 may couple with a network such as the Internet to provide audit database 140 to others substantially simultaneously with receipt and/or retrieve audit databases from other audits related to the same product.

Report generator 154 may be capable of communicating a report of the results from data processor 152 in one or more convenient formats. For instance, report generator 154 may generate a summary report for user 160 highlighting quality issues of high concern that may be cause to reject the fabricator, quality issues of concern, and quality issues that are associated with suggested improvements. Report generator 154 may also provide a detailed report to user 160 for each particular quality issue or for selected quality issues. Further, report generator 154 may provide a list of required improvements, recommended improvements, and suggested improvements.

In some embodiments, when audit analyzer 150 has access to audit databases of other audits, report generator 154 may generate a report comparing various or selected quality issues between fabricators' facilities.

User 160 is an auditor for the controlled environment 170, representing a company that has an interest in purchasing products or services from the fabricator but requires that the fabricator meets some minimum standards on selected quality issues. User 160 may be an experienced auditor, using processing device 110 and, in some embodiments, audit analyzer 150 to perform an audit much faster than previously possible, to supply the data and results of the audit to user's company electronically such as by email or other electronic transfer, and to provide results for the audit to the fabricator more quickly than previously possible. On the other hand, user 160 may be a less experienced or inexperienced auditor that can be guided through the audit by processing device 110 to perform as thorough of an audit as more experienced auditors, as well as performing the audit quickly and supplying data and analyses for the audit to the fabricator and user's company more quickly.

Controlled environment 170 may be a facility of a fabricator, upon which the fabricator places restrictions on materials that may enter, e.g., to preserve the integrity of equipment, processes, maintenance procedures, . . . 172 within the controlled environment 170 as well as the resulting product(s) prepared by the fabricator. For instance, a semiconductor fabricator must monitor and filter out the particulates in the air of a clean room in which semiconductors are processed because the scale of the circuits that are being created is comparable to dust particles normally in the air. Many such fabricators will not allow paper, or at least paper from outside the facility, to enter into their clean rooms because the particulates that may be given off of paper could potentially destroy integrated circuits being manufactured in the clean rooms.

FIG. 2 depicts an alternative processing device 200 having an audit analyzer 230 for auditing fabrication facilities and their controlled environments. In some embodiments, processing device may comprise a laptop computer such as an IBM ThinkPad™ or a PDA such as a Sony CLIE'™, Hewlett-Packard IPAQ™, or a PalmOne™ Tungsten. Processing device 200 includes interactive interface 210, Q/A database 215, audit database 220, and audit analyzer 230. Interactive interface 210 includes a graphical user interface (GUI) 212. GUI 212 provides an easy to use interface to communicate questions to and receive answers from a user. For example, GUI 212 may provide pull down menus, pop-up menus, check boxes, radio buttons, and/or similar symbolic and/or intuitive interfaces to allow a user toe easily select answers to respond to questions. GUI 212 may also provide numeric keypads to enter numbers or buttons to enter characters.

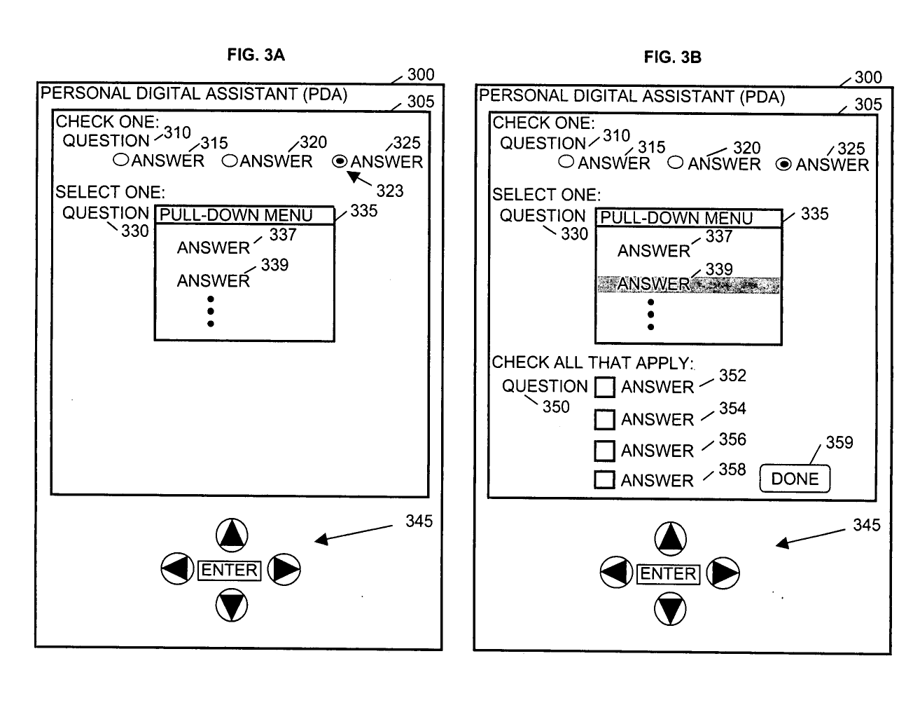

FIGS. 3A and 3B illustrate an example GUI 212, as well as two different states of the interactive interface 210 to illustrate a progression from state to state on a PDA. More specifically, FIG. 3A illustrates processing device 200 as a PDA 300. PDA 300 includes a touch-screen display 305 and control buttons 345. Touch-screen display 305 includes a display such as a color liquid crystal display with a transparent, capacitive switch grid overlay, allowing the user to touch the screen to select answers to each question posed by interactive interface 210. For example, in FIG. 3A, the user was asked question 310 and offered three answers 315, 320, and 325 as possible answers to question 310. The interactive interface 210 offers each answer 315, 320, and 320 with radio buttons like radio button 323 and, as illustrated, the user selected the radio button 323 for answer 325.

In response to selecting radio button 323, interactive interface 210 accesses Q/A database 215 to determine the next question (question 330) to ask the user to continue with the audit of the fabricator. In the present embodiment, interactive interface 210 implements a pull-down menu 335 of GUI 212 for the answers 337, 339, etc. Then, after the user selects answer 339 from pull-down menu 335, as shown in FIG. 3B, interactive interface 210 accesses Q/A database 215 to determine that question 350 should be asked next. For example, question 310 may ask “How many of these processors are actually tested?” and answers 315, 320, and 325 may include “each processor”, “a test wafer from each batch”, and “a test wafer from each bin”. Once the user selects “a test wafer from each bin”, question 330 may ask about the types of tests that the fabricator performs. In some embodiments, question 350 may continue with questions related to the same quality issue, i.e., the quality of testing, asking, for instance, about the type and extent of a response to failing such a device under test.

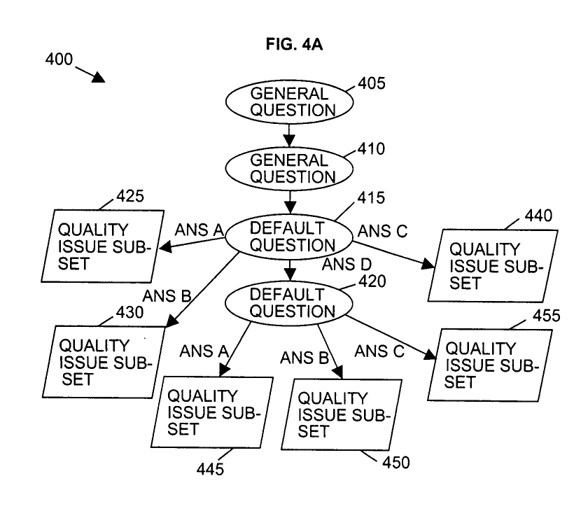

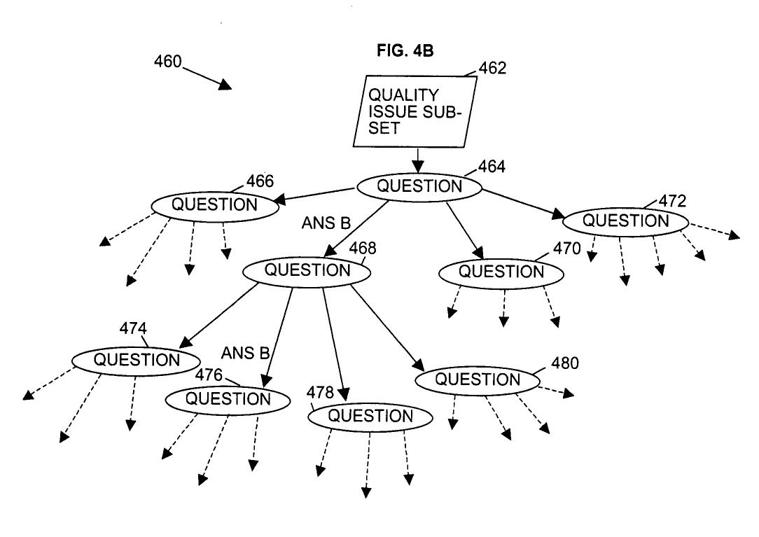

Q/A database 215 includes questions and answers such as Q/A database in FIG. 1. Q/A database 215 also includes relationships 217 and data validator 218. Relationships 217, similar to relationship table 130 of FIG. 1, may include associations between groups of questions as well as interrelationships between answers and questions within each of the groups. In particular, groups of questions may be related based upon quality issues and relationships 217 may include organization structures, such as the state diagrams 400 and 460 of FIGS. 4A and 4B, respectively, that associate questions with states and answers with state transitions.

FIG. 4A illustrates an embodiment of a general state diagram 400 that may be implemented to select or narrow questions in Q/A database 215 for improving performance and increasing efficiency of audits of a fabrication facility. As an example, the state diagram 400 illustrates that questions may begin with general questions about the fabrication facility. In some embodiments, depending upon the scope of questions maintained in Q/A database 215, the general questions 405 and 410 may begin with questions related to the type of fabrication facility, the name and location of the facility, and similarly general questions. Then, the questioning by interactive interface 210 may transition toward default questions 415 and 420, which are designed to determine the piece of equipment or process to investigate first. For example, selection of answer “ANS C” to default question 415 will result in narrowing the group of questions to be asked to a quality issue sub-set 440 of questions. “ANS C” may represent a specific answer stored in Q/A database 215 or may represent a range of answers. Thus, the user either directly selects a possible answer or enters a value that falls within the range(s) defined for one or more of the answers.

On the other hand, if the user selects “ANS D” in response to default question 415, the answer may be sufficient to reduce the number of possible quality issue sub-sets 425, 430, and 440, but leave several quality issue sub-sets 445, 450, and 455 as potential sub-sets of questions. Thus, default question 420 may be designed to narrow amongst the remaining sub-sets 445, 450, and 455 of questions.

FIG. 4B illustrates an embodiment of a more specific state diagram 460 that may be implemented to select relevant questions within a quality issue sub-set 462 in Q/A database 215. As an example, the state diagram 460 illustrates that questions may begin with a first question 464 and questioning thereafter may narrow the quality issue sub-set 462 to a sub-sets of relevant questions based upon how the user responds to each question. For example, entry of “ANS B” to question 464 may eliminate the relevancy of questions 466, 470, and 472, as well as associations between those questions and further questions within the same path. Then, upon responding again with “ANS B” to question 468, interactive interface identifies question 476 as the next question to ask and eliminates the relevancy, or changes the relevant order, for questions 474, 478, and 480.

Data validator 218 provides an indication of possible answers for each question. For questions that have only a small number of specific possible answers, a set of specific possible answers may be offered in the form of a list. On the other hand, when ranges of answers are possible, interactive interface 210 may request that the user enter a value. Interactive interface 210 then verifies that the number entered by the user is within the range of anticipated values. In some embodiments, when a number falls outside the anticipated range of values described by data validator 218, interactive interface 210 may request that the user verifies the value entered. Alternatively, interactive interface 210 may state that the value entered is invalid and request that the user enter a new value. In several such embodiments, an indication stored in data validator 218 may instruct interactive interface 210 about how to respond to the user when a value falls outside a particular range of values. In further embodiments, data validator 218 may identify ranges of values that are valid, likely invalid, and invalid, depending upon responses communicated by the user to prior questions.

Audit database 220 may function in a manner similar to the manner discussed for audit database 140. However, audit database 220 may be specifically adapted to communicate data with integrated audit analyzer 230. For instance, audit database 230 may include responses to questions posed by interactive interface 210 from Q/A database 215 in a format designed specifically to work with integrated audit analyzer 230.

Audit analyzer 230 may include a software, firmware, and/or state machines to analyze data captured by processing device 200. Similar to audit analyzer 150 from FIG. 1, audit analyzer 230 may include data processing and reporting functionality to generate one or more reports, or views of reports, based upon data stored in audit database 220. Advantageously, audit analyzer 230 may process data from audit database 220 as the data is stored in audit database 220, providing the user with potential concerns or definite concerns about quality issues substantially instantaneously.

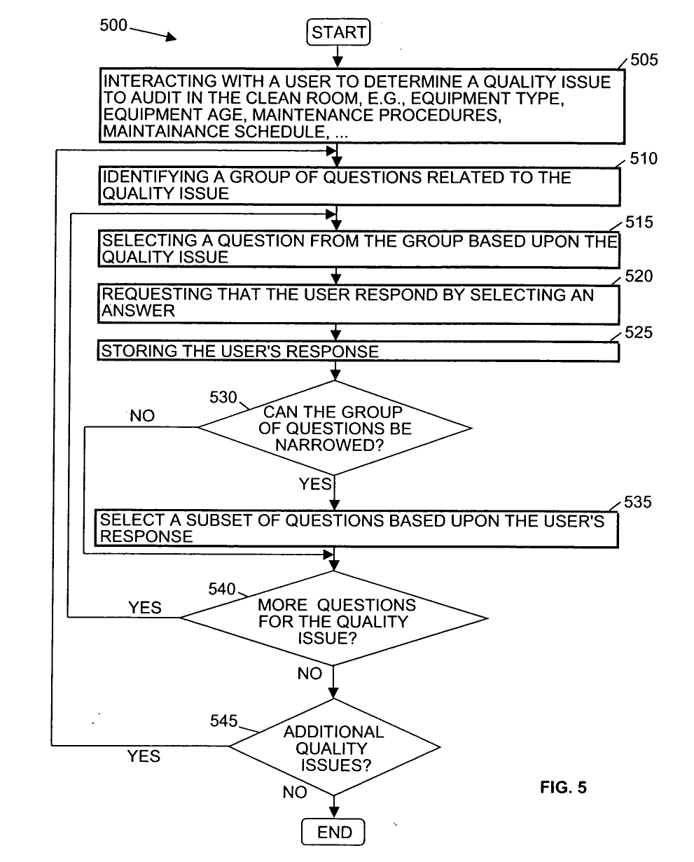

Referring now to FIG. 5, there is shown a flowchart of embodiments for improving performance and increasing efficiency of audits of a fabrication facility. In one embodiment, the software implementing flow chart 500 executes on a PDA as an auditor walks around a clean room of semiconductor fabrication facility to audit quality issues within the clean room. Advantageously, the PDA is easy to carry and manipulate while walking from location to location.

As the auditor begins the audit, an interactive interface of the PDA interacts with the auditor to gain general information about the fabricator, often for identifying the audit data and analyses. Then, the interactive interface begins to interact with the auditor, asking questions about the type of product that is under consideration and other production specific data to identify questions according to one or more quality issues that may need to be addressed during the audit.

Upon determining a set of potential quality issues to address, the interactive interface may interact with the auditor to determine the quality issue or set of quality issues to address first. For example, in some embodiments, the auditor may communicate with the interactive interface via a graphical user interface (GUI) by, e.g. selecting a pre-defined answer, to identify the quality issue to be addressed first (element 505). In particular, the auditor may indicate that a particular piece of equipment or maintenance procedure will be addressed first. In other embodiments, based upon the product to be audited, the complexity of the process to produce the product, etc., the interactive interface may indicate which quality issue that should be addressed first.

After selecting the quality issue, the interactive interface may select a group of questions related to the quality issue (element 510) from a database within or at least accessible to the PDA (e.g., wirelessly). The interactive interface may then request input from the auditor to answer the question (element 520) and upon receiving the response compare the response to a range or set of valid responses. Some embodiments provide the auditor with a set of answers including specific answers and values and/or ranges of values. For instance, the interactive interface may pose the question: “What film parameters is typically monitored?” and may offer answers such as: “(a) film thickness, (b) composition, (c) reflective index, or (d) specific gravity”. In response the auditor may press the letter of associated with the correct answer.

If the response is determined to be a valid response, the response may be stored in memory such as flash memory or a flash hard drive (element 525). On the other hand, when the response is determined to be invalid, the response may be rejected and the auditor may be asked to enter a new response. For instance, if the auditor selects a letter “e” and no answer “e” was offered, then the interactive interface may either ignore the input or request that the auditor select a letter between “a” and “d”.

The response offered by the auditor, depending upon the nature of the question, may allow the remaining questions to be evaluated for relevancy. More specifically, interactive interface determines whether one or more of the remaining questions are still relevant to the audit based upon the responses received for previous questions (element 530). When questions are no longer relevant to the audit, the group of questions selected for the audit can be narrowed by selecting a new, sub-set of questions for the audit (element 535).

On the other hand, when the remaining set of questions cannot be narrowed in light of the latest response, an additional question is selected from the remaining questions (element 515) if questions remain to be asked for the quality issue. Otherwise, when additional quality issues exist (element 545), they may be selected and addressed as with the quality issue above. After all the relevant quality issues have been addressed, the audit is concluded and an audit analyzer is implemented to process the data and generate one or more reports that indicate the performance of the facility based upon the audit.

One embodiment of the invention is implemented as a program product for use with a computer system such as, for example, the processing device 110 shown in FIG. 1. The program product could be used on a PDA, on a laptop, or any combination thereof, or on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for improving audits such as technical audits within controlled environments. It is understood that the form of the invention shown and described in the detailed description and the drawings are to be taken merely as examples. It is intended that the following claims be interpreted broadly to embrace all the variations of the example embodiments disclosed.

1. A method for improving an audit within a controlled environment, the method comprising:
determining a quality issue to address, the quality issue being associated with a product, wherein the product is the subject of the audit;
selecting a group of questions associated with the quality issue;
posing a question of the group of questions to gather information related to evaluation of the quality issue via an interactive interface adapted for operation within the controlled environment;
determining a sub-group of the group of questions, the sub-group being selected based upon an association with the information received in response to the question; and
storing the information.

2. The method of claim 1, further comprising processing the information along with other information related to the group of questions to evaluate performance related to the quality issue.

3. The method of claim 2, further comprising generating a report based upon the information to describe the performance.

4. The method of claim 1, wherein determining the quality issue comprises interacting with a user to select the quality issue.

5. The method of claim 1, wherein determining the quality issue comprises selecting a quality issue based upon the product.

6. The method of claim 1, wherein selecting the group of questions comprises searching a database for questions having an association with the quality issue.

7. The method of claim 1, wherein selecting the group of questions comprises searching a relationship table for associations with the quality issue.

8. The method of claim 1, wherein posing the question comprises displaying the question and a set of potential answers on a touch screen display of a personal digital assistant.

9. The method of claim 1, wherein determining the sub-group comprises selecting the sub-group from the group based upon relevancy of the questions for the audit in light of the information.

10. A method for performing an audit, the method comprising:
interacting via an interactive interface to invoke a response to a question from a group of questions associated with the audit;
narrowing the group of questions to a sub-group of the group based upon the response to the question, wherein the sub-group of questions are relevant to a quality issue in light of the response; and
storing the response for analysis.

11. The method of claim 10, further comprising processing the response along with other responses related to the group of questions to analyze performance with respect to the quality issue.

12. The method of claim 11, further comprising generating a report based upon the responses to describe the performance.

13. The method of claim 10, wherein interacting via the interactive interface comprises displaying a question for the audit related to the quality issue on a display adapted for operation within a controlled environment.

14. The method of claim 10, wherein narrowing the group comprises identifying questions of the group that are relevant to the quality issue based upon the response.

15. An apparatus to improve an audit, the apparatus comprising:
an interactive interface to invoke a response to a question from a group of questions associated with the audit and to narrow the group to a sub-group based upon the response to the question, wherein the sub-group is relevant to a quality issue in light of the response;
a question database coupled with the interactive interface, the question database having the group of questions, wherein the group of questions are invoked in an order based upon the response; and
an audit database coupled with the interactive interface, to store data, wherein the data represents the response and responses to other questions from the group.

16. The apparatus of claim 15, further comprising an audit analyzer coupled with the audit database to analyze the data to evaluate performance related to the quality issue and to generate a report communicate the evaluation.

17. The apparatus of claim 15, further comprising a relationship table coupled with the interactive interface to describe associations between the quality issue and responses to questions of the group of questions.

18. The apparatus of claim 15, wherein the interactive interface comprises a graphical user interface for a display adapted for use within a controlled environment, to interact with a user.

19. The apparatus of claim 15, wherein the question database comprises questions determined by an experienced auditor.

20. The apparatus of claim 19, wherein the question database comprises answers to the questions, wherein the answers are determined by the experienced auditor.

21. A machine-accessible medium containing instructions, which when executed by a machine, cause said machine to perform operations, comprising:
determining a quality issue to address, the quality issue being associated with a product, wherein the product is the subject of an audit;
selecting a group of questions associated with the quality issue;
posing a question of the group of questions to gather information related to evaluation of the quality issue via an interactive interface adapted for operation within a controlled environment;
determining a sub-group of the group of questions, the sub-group being selected based upon an association with the information received in response to the question; and
storing the information.

22. The machine-accessible medium of claim 21, further comprising processing the information along with other information related to the group of questions to evaluate performance related to the quality issue and generating a report based upon the information to describe the performance.

23. The machine-accessible medium of claim 21, wherein determining the quality issue comprises selecting a quality issue based upon the product.

24. The machine-accessible medium of claim 21, wherein selecting the group of questions comprises searching a database for questions having an association with the quality issue.

25. The machine-accessible medium of claim 21, wherein determining the sub-group comprises selecting the sub-group from the group based upon relevancy of the questions for the audit in light of the information.

26. A machine-accessible medium containing instructions, which when executed by a machine, cause said machine to perform operations, comprising:
interacting via an interactive interface to invoke a response to a question from a group of questions associated with an audit;
narrowing the group of questions to a sub-group of the group based upon the response to the question, wherein the sub-group of questions are relevant to a quality issue in light of the response; and
storing the response for analysis.

27. The machine-accessible medium of claim 26, further comprising processing the response along with other responses related to the group of questions to analyze performance with respect to the quality issue and generating a report based upon the responses to describe the performance.

28. The machine-accessible medium of claim 26, wherein interacting via the interactive interface comprises displaying a question for the audit related to the quality issue on a display adapted for operation within a controlled environment.
